(19) United States
(12) Patent Application Publication
(10) Pub. No.: US 2024/0241485 A1
(43) Pub. Date: Jul. 18, 2024

(54) COMPUTER-IMPLEMENTED METHOD AND SYSTEM FOR DETERMINING OPTIMIZED SYSTEM PARAMETERS OF A TECHNICAL SYSTEM USING A COST FUNCTION

(71) Applicant: Continental Automotive Technologies GmbH, Hannover (DE)

(72) Inventors: Christian Wirth, Niederhöchstadt (DE); Jörg Dietrich, Mainz (DE)

(73) Assignee: Continental Automotive Technologies GmbH, Hannover (DE)

(21) Appl. No.: 18/561,977

(22) PCT Filed: May 19, 2022
(86) PCT No.: PCT/DE2022/200101

§ 371 Date: Nov. 17, 2023

(30) Foreign Application Priority Data
May 19, 2021 (DE) 10 2021 205 097.2

(51) Int. Cl. G05B 13/04; G05B 13/02

(52) U.S. Cl. CPC G05B 13/042; G05B 13/029

(57) ABSTRACT

A method for determining technical system parameters using a cost function. The technical system has system parameter-adjustable components. When system parameters are set, the technical system generates component output values. The method includes
determining a definition space in which the cost function lies,
determining random system parameters in the definition space,
applying the random system parameters to the technical system and determining the output values,
technical system modeling by training a statistical analysis method,
generating technical system rules using the system parameters and the output values,
generating probability functions using the rules, each indicating the probability which satisfy the rules by any cost function,
combining probability functions to determine the cost function by maximizing overall probability of all rules,
optimizing the system parameters given the cost function, and
outputting the optimized system parameters for adjusting the technical system components.

### CROSS-REFERENCE TO RELATED APPLICATIONS

The present application is a National Stage Application under 35 U.S.C. § 371 of International Patent Application No. PCT/DE2022/200101 filed on May 19, 2022, and claims priority from German Patent Application No. 10 2021 205 097.2 filed on May 19, 2021, in the German Patent and Trademark Office, the disclosures of which are herein incorporated by reference in their entireties.

### TECHNICAL FIELD

The invention relates to a computer-implemented method for determining a cost function, wherein the cost function is provided for the purpose of determining optimized system parameters of a technical system, wherein the technical system has different components that can be adjusted by the system parameters, and wherein, when the system parameters are set, the technical system generates different output values for the different components. The invention further relates to a computer system.

### BACKGROUND

Complex technical systems (or installations) have many components that must be adjusted with system parameters. Experience has shown that determining the parameters in particular poses great difficulties.

These parameterization problems are generally problems in which the technical system has freely selectable parameters that influence the system behavior, whereby the system behavior is subject to evaluation.

Approximation methods or algorithms can be used to determine suitable parameters.

Those problems in which the parameters represent free variables and a so-called cost function, which represents an evaluation function, is intended to be optimized are considered optimization problems. This cost function describes the quality of the selected parameters and is evaluated by testing the effect of the parameters using the system. In most cases, there is also no scalar cost function because the physical system provides a plurality of output values and the output values cannot be directly interpreted as costs (or benefits). This means that the expected quality is not directly one of the (numerical) output values. The output of the system then forms the input of the cost function, with the cost function being implicitly determined by the system or by experts. This means that the system has output values that can be used to represent the quality of the system.

Furthermore, system parameters usually have to be determined individually for each parameterization problem using experts and expert knowledge, with a change in the model or minor changes to the technical system making complex new determinations necessary. However, cost functions determined by experts require a clear, reliable definition that enables automatic evaluation. This is usually not possible due to only abstract expert knowledge.

Furthermore, the cost function must be adapted to specific customer requirements, which in turn requires a corresponding expert process.

The document Zanchetta et al., “Heuristic Multi-Objective Optimization for Cost Function Weights Selection in Finite States Model Predictive Control,” Predictive Control of Electrical Drives and Power Electronics Conference, pp. 70-75 (2011), thus discloses an automated and optimal method for selecting the weights of the cost function in finite states model predictive control. This optimization method provides a set of optimized solutions, which is called a Pareto optimal set. Each Pareto optimal solution is superior to all other points in the set with respect to at least one of the performance indicators. The group of corresponding values of the performance indicators is called a Pareto optimal front. The algorithm can minimize all performance indicators at once or only a portion of them, depending on the specific design requirements. After optimization, the expert selects a solution from the Pareto front, which in turn requires expert experience or expert intuition.

The document M. Saerens, “Building Cost Functions Minimizing to Some Summary Statistics,” IEEE TRANSACTIONS ON NEURAL NETWORKS, vol. 11, no. 6, pp. 1263-1271 (2000), discloses conditions for a given cost function that ensure that the output of a trained model approximates the conditional expectation of the desired output for given variables, the conditional median and the geometric mean and the conditional variance. It is assumed that a scalar cost target is already known and that the function space is doubly differentiable. This means that it is a precise target definition, not abstract expert knowledge.

The document M. Wulfmeier et al., “Incorporating Human Domain Knowledge into Large Scale Cost Function Learning,” 30th Conf. on Neural Information Processing Systems: Deep Reinforcement Learning Workshop, pp. 1-8 (2016), discloses an approach to incorporating prior human knowledge into cost function learning in the context of inverse reinforcement learning by pretraining a regression model for a manual cost function and refining it based on maximum entropy deep inverse reinforcement learning. It is not necessary for expert rules to be defined here.

The document L. Hewing et al., “Cautious Model Predictive Control Using Gaussian Process Regression,” IEEE Transactions on Control Systems Technology, vol. 28, no. 6, pp. 2736-2743 (2020), discloses a model predictive control approach that integrates a nominal system with an additive nonlinear part of the dynamics modeled as a Gaussian process. The authors are not concerned with determining a cost function, but generally with a Gaussian process regression.

In particular, the consideration of which output values should have how much influence on the cost function is often impossible to decide precisely and is often subject to expert experience or expert intuition. In addition, the expert must ensure that all relevant influences are correctly taken into account.

Therefore, in practice, determining a cost function is an iterative process in which the expert considers the optimized system parameters to further adjust the cost function until the result meets expectations. However, this is costly and time-consuming.

WO 2001 061 573 A2 discloses a method for calculating a model of a technical system that has a functional structure with functions and at least one undetermined parameter, having the steps of: querying the functional structure of the model; querying a data file; creating an optimization environment for calculating the parameters of the model; generating starting values for the at least one undetermined parameter from the functional structure; calculating and outputting the parameters.

### SUMMARY

It is therefore an object of the present disclosure to specify a computer-implemented method for the essentially automated determination of optimized system parameters of a technical system using a cost function, wherein the cost function is provided for the purpose of determining optimized system parameters of the technical system. Another object is also to specify a corresponding computer system.

The object is addressed by a computer-implemented method having the features of claim 1 and a computer system having the features of claim 8.

The subclaims relate to advantageous embodiments and developments which can be used individually or in combination with one another.

The object is addressed by a computer-implemented method for determining optimized system parameters of a technical system using a cost function, wherein the cost function is provided for the purpose of determining optimized system parameters of the technical system, wherein the technical system has different components that can be adjusted by the system parameters, and wherein, when the system parameters are set, the technical system generates different output values for the different components, the method including the steps of:
determining a function space with a definition space, wherein the function space corresponds to a set of functions in which the cost function lies,
determining random system parameters that lie in the definition space,
applying the random system parameters to the technical system and determining the output values corresponding to the random system parameters,
modeling the technical system by way of a statistical analysis method, and training the statistical analysis method using the system parameters as input values and the output values as target values, and
generating a plurality of rules on which the technical system is based and which are based on the different system parameters and the corresponding output values,
generating a plurality of probability functions using one or more rules, wherein each of the probability functions indicates the probability with which the underlying rule is satisfied by any cost function from the function space,
combining all probability functions in order to determine the cost function by maximizing the overall probability of all rules,
optimizing the system parameters given the cost function, and
outputting the optimized system parameters in order to adjust the components of the technical system.

The combination of all probability functions in order to determine the cost function can be understood to mean, for example, that the cost function is determined as a function from the function space in such a way that the probability function is maximized when the selected function is applied to the output values.

The probability functions thus form the optimization goal for determining a cost function within the function space. Therefore, the combination of the probability functions is not understood to mean a multidimensional optimization goal, but rather a scalar one. This means that the computer-implemented method gradually optimizes new (cost) function parameters until they maximize the overall degree of satisfaction with regard to the expert rules.

It was recognized that in many (engineering) areas no automated methods are yet used to resolve the optimal system parameters of a technical system under the restrictions mentioned above.

It was further recognized that the return value of the cost function should be a scalar value in order to make it possible to clearly determine a best solution. The computer-implemented method also no longer requires an expert who has to choose a solution from the Pareto front after optimization, which in turn requires expert experience or expert intuition.

It was further recognized that these parameterization problems constitute a double optimization problem in relation to the technical system. On the one hand, the cost function must be optimized, as well as the actual system parameters. This is now solved using the computer-implemented method.

The computer-implemented method is not based on a predefined cost function, but rather on a multiplicity of rules and examples which are intended to be complied with by the cost function. The technical system is based on these rules.

No optimal system parameters are therefore found by determining the cost function, but rather the function that describes the optimization goal for determining the optimal system parameters.

The method generates a scalar cost function that enables autonomous optimization. It is no longer necessary for experts to select the best result, for example from a Pareto set, i.e. the expert only has to define rules, not specific target values, since the resulting cost function has a scalar return value and therefore no Pareto front is created here.

First, a function space in which the desired cost function lies is determined.

A function space is a set of functions that all have the same definition range and that can be defined by determining function parameters. Usually the function space is infinitely dimensional. The function space can, for example, be modeled automatically and/or by experts or automatically in conjunction with experts or by a machine learning method, or the proposed function space can be reduced thereby. The functions common in machine learning such as kernel functions or neural networks can be used here. An expert system with expert knowledge can also be used to model the function space.

Furthermore, random system parameters which lie in the definition space are determined. These can be selected/determined automatically or by an algorithm.

Furthermore, the random system parameters are applied to the technical system and the corresponding output values are thereby determined and stored or logged.

Furthermore, the technical system is modeled by way of an adaptive statistical analysis method. The statistical analysis method is trained by virtue of the random system parameters representing the input values and the output values representing the target values.

The system parameters and output values can thus be used as training data for the statistical analysis method in order to predict later output values of any system parameters based on the training data. Such a statistical analysis method can be, for example, a regression analysis, for example a Gaussian process regressor.

Such a regression analysis can also determine the uncertainty of the prediction. Since not all possible combinations of system parameters can be tested, there is always an uncertainty or inaccuracy related to the model. In addition, uncertainties can arise due to random and natural fluctuations in the technical system and the lack of precise knowledge about the technical system. This means that the technical system can only be modeled with certain uncertainties and probabilities due to incomplete information.

Furthermore, a plurality of rules on which the technical system is based and which are based on the different system parameters and the corresponding output values are generated.

The individual rules can be dependent on each other. The rules can be specified, for example, in a preference representation form, ordinal and/or numerical representation form depending on the system parameters.

Examples of such rules are:
The output values of the system parameters i are better than those of the system parameters j;
The output values of the system parameters k can be considered very poor.

An expert's expectations of the behavior of the technical system can be defined with the aid of the rules or examples. Such rules can be based on a wealth of experience and/or may be limit values for the machine parameters/machine settings on which the system is operationally based and which should be complied with by the machine/technical system during its adjustment (operation) (e.g. as minimum and maximum system parameters to avoid overload or malfunctions) or output values that should be complied with by the technical system in the various operating modes. The individual rules can also be dependent on each other. The rules can be generated automatically, for example, using an expert system.

The rules can also be weighted in order to indicate that not all rules are equally reliable.

Furthermore, the rules determined above are translated as probability functions, wherein each of the probability functions indicates the observed probability with which the rules are satisfied by any cost function from the function space.

The cost function is determined, i.e. its function parameters, by determining that cost function from the function space which maximizes the probability by applying the cost function with known output values and by maximizing the degree of fulfillment of the probability function. Thus, the cost function can be optimized with the aid of an optimization method by maximizing the observed probabilities.

The rules can preferably, but not necessarily, always each be translated as a pairwise probability function. This means that the existing rules are translated into pairwise probability functions. In this case, pairs are respectively formed for which the rule applies. The probability may be designed, for example, as a sigmoid function.

The cost function results from the resulting determined probability functions. The cost function can be optimized with the aid of an optimization method. This allows optimized or new system parameters to be found.

Subsequently, as a second optimization step, the system parameters can be determined on the basis of the now determined cost function which minimizes the costs of the system, given by applying the cost function to the resulting output values.

The computer-implemented method can also be used to determine system parameters without human experimentation, which can ensure a high level of quality.

The computer-implemented method also allows expert knowledge to be reproduced in an understandable notation.

Furthermore, the quality of the system parameters can be explicitly determined and justified using the computer-implemented method.

The rules can be based on preferences, ordinal ratings and numerical ratings of the system parameters and their output values.

According to one embodiment variant, it is possible for the technical system to be represented or simulated virtually as a simulation. This makes it possible to more easily determine and, above all, validate the optimized system parameters than when using the real technical system to validate determined optimized system parameters.

According to one embodiment, the technical system is a physical system in which the system behavior (or components of the technical system) can be changed by freely adjustable parameters (manipulated variables). This means that certain manipulated variables (of the components of the technical system) can be changed mechanically, electrically or digitally, as a result of which measurable properties of the system change. This raises the problem of optimal manipulated variables in relation to the measurable properties.

As an embodiment variant, it is possible for the physical system to be represented virtually as a simulation, which simplifies changing the manipulated variables and measuring the properties.

One embodiment relates to the determination of optimal parameters for operating a control unit (an ECU, electronic control unit), for example in a vehicle.

In a further configuration, the computer-implemented method includes the further steps of:
inputting the optimized system parameters obtained by the determined cost function into the trained statistical analysis method and determining the new output values by way of the statistical analysis method.

Furthermore, these steps can be iterated.

This iteration may be used to find optimal system parameters by using an optimization method to determine the system parameters that minimize the most likely cost function. This allows the parameters with the lowest costs to be identified.

In a further configuration, the method includes an abort criterion. This can be at predefined minimum costs.

In a further configuration, the statistical analysis method and the cost function each have an uncertainty.

In a further embodiment, the computer-implemented method includes the further steps of:
optimizing the cost function with regard to the uncertainties in order to obtain optimized system parameters, and inputting the system parameters optimized thereby into the trained statistical analysis method, and determining the new output values by way of the statistical analysis method.

Furthermore, these steps can be iterated.

This means that the combined uncertainty is minimized over the parameter space and the function space of the cost function.

Furthermore, the computer-implemented method can use methods from the field of active learning to optimize the uncertainty of the cost function and the uncertainty of the statistical analysis method.

Active learning is understood to mean essentially the possibility of obtaining the correct outputs for some of the inputs. The questions that promise a high level of information gain can be determined automatically in order to keep the number of questions as small as possible.

If active learning methods are therefore used to determine the system parameters that minimize the combined uncertainty over the parameter space and the function space of the cost function, a very good result can be achieved in a short time.

The computer-implemented method allows active learning to be used to reduce the number of parameter sets to be evaluated and thus the effort (costs and time).

A regression analysis is preferably used as the statistical analysis method. A regression analysis can be used to model relationships between dependent and independent variables. However, the significance of such a regression rests on the completeness of the model; the more complete the model, the better the result.

Such a regression can be used particularly for complex relationships.

In a further configuration, a Gaussian process regression is used as the regression analysis. An advantage of regression using Gaussian processes is that both the function values and their uncertainties can be easily determined.

Furthermore, the object is achieved by a computer system which is configured to determine optimized system parameters of a technical system using a cost function. The cost function is provided for the purpose of determining optimized system parameters of the technical system. The technical system has different components that can be adjusted by the system parameters and, when the system parameters are set, the technical system generates different output values for the different components. The computer system has a processor which is designed to determine a function space with a definition space, wherein the function space corresponds to a set of functions in which the cost function lies.

The processor is further designed to determine random system parameters which lie in the definition space and to apply the random system parameters to the technical system in order to thereby determine output values corresponding to the random system parameters.

The processor is further designed to model the technical system by way of a statistical analysis method, as well as to train the statistical analysis method using the system parameters as input values and the output values as target values.

The processor is further designed to generate a plurality of rules on which the technical system is based and which are based on the various system parameters and the corresponding output values, and to generate a plurality of probability functions using one or more rules. Each of the probability functions indicates the probability with which the underlying rule is satisfied by any cost function from the function space.

An optimization unit is provided and configured to combine all probability functions by maximizing the overall probability of all rules and to optimize the system parameters given the cost function.

The computer system finally has an output unit which is designed to output the optimized system parameters in order to adjust the components of the technical system.

The advantages of the method can also be applied to the computer system.

In a further configuration, the processor is designed to optimize the cost function with respect to the costs in order to obtain optimized system parameters and to input the optimized system parameters into the trained statistical analysis method and to determine the new output values by way of the statistical analysis method.

The processor can be configured to abort the computer-implemented method in the case of an abort criterion, wherein the abort criterion depends on predefined costs.

Furthermore, the statistical analysis method may have an uncertainty and the cost function may have an uncertainty. The processor can be further designed to optimize the cost function with regard to the uncertainties in order to obtain optimized system parameters and to input the system parameters optimized thereby into the trained statistical analysis method and to determine the new output values by way of the statistical analysis method.

### BRIEF DESCRIPTION OF THE DRAWINGS

Further properties and advantages of the present disclosure emerge from the following description with reference to the accompanying figures, in which, schematically:

FIG. 1: schematically shows the method, and

FIG. 2: schematically shows the method using a closing system.

### DETAILED DESCRIPTION

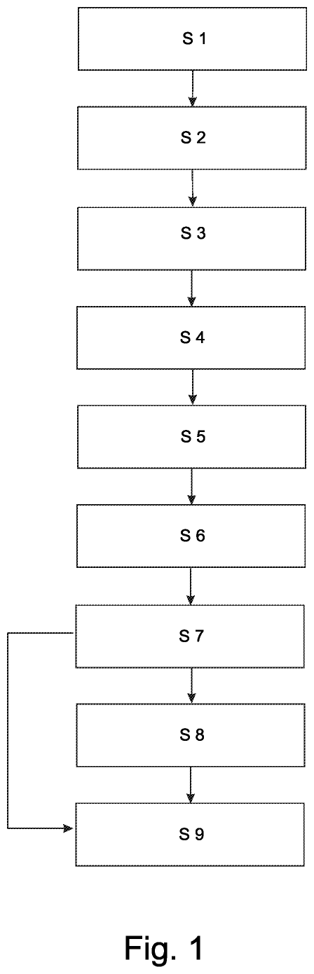

FIG. 1 schematically shows the method for determining a cost function. The cost function is provided for the purpose of determining optimized system parameters of a technical system.

The technical system has different components that can be adjusted by the system parameters. When the system parameters are set, the technical system generates different output values for the different components.

Such technical systems are all systems that have parameterization problems. Parameterization problems are problems in which a technical system has freely selectable system parameters that influence the system behavior, whereby the system behavior is subject to evaluation. In such a technical system, the system parameters represent free variables that are optimized using a cost function (evaluation function). This cost function describes the quality of the system and is evaluated by testing the effect of the system parameters using the technical system or a simulation of the system. The output of the system (output values) then forms the input of the cost function.

An environment for such parameterization problems is, for example, automatic closing systems for tailgates, (sliding) doors, windows or sliding roofs, drive units and injection systems, transmission systems, exhaust gas regulation systems, manufacturing and production processes, circuit boards, temperature protection systems, etc.

In a first step S1, a function space with a definition area in which the desired cost function lies is determined. The function space can be infinitely dimensional. The function space can, for example, be modeled automatically and/or by experts or automatically in conjunction with experts or by a machine learning method. Furthermore, the proposed function space can be reduced by means of a machine learning method. The functions common in machine learning such as kernel functions or neural networks can be used here. An expert system with expert knowledge can also be used to model and reduce the function space. This also reduces the amount of data required.

In a second step S2, random system parameters which lie in the definition space are determined. These can be determined automatically using an algorithm.

The selected system parameters are input into the technical system in a third step S3 in order to obtain corresponding output values.

In a fourth step S4, the system parameters and the output values are now used as training data for a regression analysis, in particular a Gaussian process regression. The system parameters are used as input values and the output values are used as target data. The regression is trained to predict the output values based on the input values.

Furthermore, the uncertainty of the prediction is determined by the regressor.

In a fifth step S5, a plurality of rules on which the technical system is based and which are based on the different system parameters and the corresponding output values are generated.

The system parameters and the output values are thus evaluated based on the rules. The evaluation can be carried out, for example, by an expert system with expert knowledge.

The individual rules can be dependent on each other. The rules can be specified, for example, in a preference representation form, ordinal and/or numerical representation form depending on the system parameters.

Examples of such rules are:
The output values of the system parameters x are very good.
The output values of the system parameters y are worse than those of the system parameters x.

In a sixth step S6, these rules can be translated primarily into pairwise probability functions. This means that the existing rules are translated into pairwise probability functions.

Not only pairwise probability functions can be formed, but also probability functions that satisfy one or more rules. The rules are thus translated as a probability function with which observed probability the applied rules are satisfied by any cost function from the function space.

In a seventh step S7, all probability functions are combined in order to determine the cost function by increasing and maximizing the overall probability of all rules, i.e. the cost function is determined as a function from the function space such that the probability function is maximized when the selected function is applied to the output values.

The probability functions thus form the optimization goal for determining a cost function within the function space. Therefore, the combination of the probability functions is not understood to mean a multidimensional optimization goal, but rather a scalar one.

The cost function is optimized with respect to the probabilities, for given expert rules and known output values. This cost function is then suitable for optimizing the system parameters.

In an eighth step S8, optimal, updated system parameters are generated based on the determined cost function. The optimized system parameters are then input into the trained statistical analysis method and the new output values are determined by way of the statistical analysis method. Furthermore, new rules and probabilities can be generated based on these new output values and system parameters.

This iteration can be used to find optimal, updated system parameters by using an optimization method to determine the system parameters that minimize the most likely cost function. This allows the parameters with the lowest costs to be identified.

An abort criterion can also be defined, for example that the method stops in the case of a predefined minimum cost value.

In an additional or alternative ninth step S9, the cost function is reduced and minimized with regard to the uncertainty of the cost function and the uncertainty of the regression method using methods from the field of active learning and optimal system parameters are generated. The optimized system parameters can then be input into the trained statistical analysis method and new output values can be determined by way of the statistical analysis method. Furthermore, new rules and probabilities can be generated based on these new output values and system parameters.

This determines the output values/system parameters that minimize the uncertainty of the regression method and the uncertainty of the cost function.

This means that the combined uncertainty is reduced and minimized over the parameter space and the function space of the cost function.

Active learning is understood to mean essentially the possibility of obtaining the correct outputs for some of the inputs. The questions that promise a high level of information gain can be determined automatically in order to keep the number of questions as small as possible. If active learning methods are therefore used to determine those system parameters which minimize the combined uncertainty over the parameter space and the function space of the cost function, a very good result can be achieved in a short time. The computer-implemented method allows active learning to be used to reduce the number of parameter sets to be evaluated and thus the effort (costs and time).

In a further step, not shown, the generated optimized system parameters are output in order to adjust the components of the technical system.

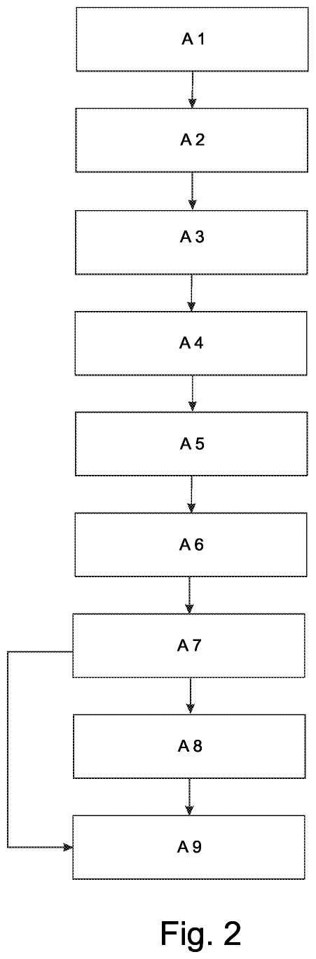

FIG. 2 describes the computer-implemented method using the example of a closing system for vehicles.

In the field of electrical closing systems for vehicles, such as tailgates, doors or window regulators, parameterizable systems are responsible for detecting whether an object/person is trapped and therefore the closing process must be aborted. These closing systems not only influence entrapment detection, however, but also the closing behavior itself. In addition, the closing behavior may be subject to explicit requirements of the vehicle manufacturer.

In a first step A1, the function space with a definition space for the system parameters is determined. For example, it is known here that the maximum closing force must always be below a certain value. Therefore, this part of the cost function can be determined using a limit value function G_{y}, for which, however, it has not yet been determined how quickly the costs will increase if the limit value is exceeded.

The evaluation of undetected and incorrectly detected entrapments, however, is comparable to a binary classification. Therefore, common evaluation mechanisms such as the F-beta score FB can be used for this, but the beta value is not known.

In addition, it must be determined how the two parts of the cost function relate to each other.

To determine the cost function c with different function parameters:

$$c = {α}_{1} * {F}_{β} + {α}_{2} * {G}_{γ}$$

it is therefore necessary to learn the gradient value γ of the limit value function G, the @ factor and the weighting α₁, α₂ of the two terms.

In a second step A2, system parameters are selected and are input as input data into the technical system in order to obtain appropriate corresponding output values (third step A3).

In a fourth step A4, the system parameters and the corresponding output values are used as training data for a regression. The selected system parameters represent the input values for the regressor, while the observed output values define the target values. Here, it is preferably possible to train a Gaussian process or a Gaussian process regression which is able to predict not only an expected value but also the uncertainty. A Gaussian process represents essentially temporal, spatial or any other functions whose function values can only be modeled with certain uncertainties and probabilities due to incomplete information. The expected value of a random variable describes the number assumed by the random variable on average.

In a fifth step A5, for example, rules on which the technical system is based are automatically defined based on the system parameters and their output values.

These rules can be, for example:
1. The results of the system parameters i are better than those of the system parameters j,
2. The results of system parameters x are very good and have costs of 0.1.

Furthermore, empirical values or operating parameters (from the manufacturer) or customer requirements can be formulated as a rule. The rules can also be weighted in order to indicate that not all rules are equally reliable. For example, the first rule is given a higher rating than all others.

These rules can be based on preferences, ordinal ratings and numerical ratings of the system parameters/output values.

In a sixth step A6, a plurality of pairwise probability functions are generated using a rule. The rule is translated, for example, as a pairwise probability function.

For example, the first rule can be defined as a sigmoid function of the cost difference. A sigmoid function is a mathematical function with an S-shaped graph.

This results in the probability function if, for example, the system parameters x are better than the system parameters y:

$$p = sigmoid ( x - y ) .$$

The second rule can be represented using a variable normal distribution. This means that all system parameters x are given a probability function:

$$p = N ( 0 , σ ) * p d f ( x )$$

where N is the normal distribution, 0 stands for a “good” cost value, o describes the variance as a free variable and pdf is the point probability (probability density function) which only relates to the system parameter x.

The probability functions each indicate the correctness of the rule in relation to the system parameters of the cost function.

In a seventh step A7, the final probability function is determined from the set of all probability functions that were derived from the rules.

The result of the seventh step A7 is now a function that defines the probability of the correctness of the cost function depending on the free parameters γ, β, α₁, α₂, σ.

The probability and uncertainty of various function parameters can be determined using posterior sampling methods. One such posterior sampling method is the Hamiltonian Monte Carlo method, for example. The Hamiltonian Monte Carlo (HMC) is a Markov chain Monte Carlo method (MCMC).

To determine the potentially best system parameters, the function parameters that have the highest probability are used. This allows the cost function to be fully defined. This means that optimized system parameters are known.

In an eighth step A8, the cost function is optimized with respect to the costs and the optimized system parameters are input into the trained Gaussian process regressor in order to predict the output values for the optimized system parameters and thus determine their expected costs. This allows the system parameters with the lowest costs to be identified.

An abort criterion can also be defined, for example that the method stops in the case of a predefined minimum cost value.

Since the uncertainty of the cost function parameters as well as the prediction of the output values of the Gaussian process regressor are known, it can be determined in an additional or alternative ninth step A9 how large the combined uncertainty is. It is possible to use optimization methods from the field of active learning which attempt to minimize this uncertainty as quickly as possible. For example, the Lower Confidence Bound (LCB) can be used to select new system parameters. This means that the system parameters with the lowest expected costs are not chosen, but rather the system parameters that minimize the uncertainty.

This means that the combined uncertainty is reduced and minimized over the parameter space and the function space of the cost function.

The example described in FIG. 2 is described again below in a generalized and simplified manner, showing how the cost function is determined for a given optimization method:
choosing function parameters, whereby a cost function is determined,
applying this cost function to the known output values and observing the resulting costs,
determining the probability functions based on the satisfaction of the defined expert rules by
   applying the sigmoid function (or another function that maps the costs to probabilities) to the cost differences of the known output values, where the cost difference (positive, negative) is accomplished by the pairwise comparisons of the output values based on the expert rules, and multiplying all satisfaction probabilities (all rules/comparisons), so that an “overall degree of satisfaction” is obtained as a result,
applying the optimization method in order to gradually generate new function parameters until this “overall degree of satisfaction” is maximized, so that the cost function is optimized thereby, wherein the optimized cost function is that function which describes the optimization goal,
outputting the optimized function parameters.

1. A computer-implemented method for determining system parameters of a technical system using a cost function, the method comprising:
providing the cost function for the purpose of determining system parameters of the technical system, wherein the technical system has different components that are adjustable by the system parameters, and
wherein, when the system parameters are set, the technical system generates different output values for the different components,
determining a function space with a definition space, wherein the function space corresponds to a set of functions in which the cost function lies, and
determining random system parameters that lie in the definition space, and
applying the random system parameters to the technical system and determining the output values corresponding to the random system parameters, and
modeling the technical system by way of a statistical analysis method, and training the statistical analysis method using the system parameters as input values and the output values as target values, and
generating a plurality of rules on which the technical system is based and which are based on the different system parameters and the corresponding output values,
generating a plurality of probability functions using one or more of the plurality of rules, wherein each of the probability functions indicates a probability with which the rule is satisfied by any cost function from the function space,
combining all probability functions in order to determine the cost function by increasing the overall probability of all rules,
updating the system parameters given the cost function, and
outputting the updated system parameters in order to adjust the components of the technical system.

2. The computer-implemented method as claimed in claim 1, further comprising:
inputting the updated system parameters obtained by the determined cost function into the trained statistical analysis method and determining the new output values by way of the trained statistical analysis method.

3. The computer-implemented method as claimed in claim 2, further comprising:
aborting the computer-implemented method in a case of an abort criterion, wherein the abort criterion depends on predefined costs.

4. The computer-implemented method as claimed in claim 1, wherein the trained statistical analysis method has an uncertainty and the cost function has an uncertainty, and wherein the computer-implemented method further comprises:
reducing the cost function with regard to the uncertainties in order to obtain the updated system parameters, and inputting the system parameters updated thereby into the trained statistical analysis method, and determining new output values by way of the trained statistical analysis method.

5. The computer-implemented method as claimed in claim 4, wherein methods from a field of active learning are used to reduce the uncertainty of the cost function and the uncertainty of the trained statistical analysis method.

6. The computer-implemented method as claimed in claim 1, wherein a regression analysis is used as the trained statistical analysis method.

7. The computer-implemented method as claimed in claim 6, wherein a Gaussian process regression is used as the regression analysis.

8. A computer system configured to determine system parameters of a technical system using a cost function, wherein the cost function is provided for the purpose of determining optimized system parameters of the technical system, wherein the technical system has different components that can be adjusted by the system parameters, and wherein, when the system parameters are set, the technical system generates different output values for the different components, the computer system comprising:
a processor, wherein the processor is designed configured to determine a function space with a definition space, wherein the function space corresponds to a set of functions in which the cost function lies, and wherein
wherein the processor is further configured to determine random system parameters which lie in the definition space and to apply the random system parameters to the technical system in order to thereby determine output values corresponding to the random system parameters,
wherein the processor is further designed configured to model the technical system by way of a statistical analysis method, as well as to train the statistical analysis method using the system parameters as input values and the output values as target values,
wherein the processor is further configured to generate a plurality of rules on which the technical system is based and which are based on the various system parameters and the corresponding output values, and to generate a plurality of probability functions using one or more rules, wherein each of the probability functions indicates a probability with which the rule is satisfied by any cost function from the function space,
wherein the computer system combines all probability functions in order to determine the cost function by increasing an overall probability of all rules, and
wherein the processor is further configured to update the system parameters given the cost function, and
wherein the computer system includes one or more outputs on which is placed the updated system parameters in order to adjust the components of the technical system.

9. The computer system as claimed in claim 8,
wherein the processor is further configured to optimize update the cost function with respect to the costs in order to obtain optimized the updated system parameters and to input the updated system parameters into the trained statistical analysis method and to determine new output values by way of the statistical analysis method.

10. The computer system as claimed in claim 8, wherein the statistical analysis method has an uncertainty, and the cost function has an uncertainty, and the processor is further configured to reduce the cost function with regard to the uncertainties in order to obtain the updated system parameters, to input the system parameters updated thereby into the trained statistical analysis method, and to determine the new output values by way of the statistical analysis method.

11. The computer system as claimed in claim 8, wherein the statistical analysis method is designed as a regression analysis.
